(19) United States
(12) Patent Application Publication
(10) Pub. No.: US 2012/0031131 A1
(43) Pub. Date: Feb. 9, 2012

(54) Vehicle, in particular motor vehicle, having absoption refrigerating machine

(76) Inventors: Vladimir Danov, Erlangen (DE); Andreas Schröter, Anrode/Bickenriede (DE)

(21) Appl. No.: 13/138,339

(22) PCT Filed: Nov. 26, 2009
(86) PCT No.: PCT/EP2009/065904

§ 371 Date: Aug. 3, 2011

(30) Foreign Application Priority Data
Feb. 3, 2009 (DE) 10 2009 007 231.4

(51) Int. Cl. B60H 1/32

(52) U.S. Cl. 62/239

(57) ABSTRACT

A motor vehicle has a drive device or engine which generates waste heat. An air conditioning system cools a passenger compartment and/or at least one component of the vehicle. The cooling device is designed as an absorption refrigerating machine which utilizes the waste heat from the drive device, in particular as a diffusion absorption refrigerating machine.

### CROSS REFERENCE TO RELATED APPLICATIONS

This application is based on and hereby claims priority to International Application No. PCT/EP2009/065904 filed on Nov. 26, 2009 and German Application No. 10 2009 007 231.4 filed on Feb. 3, 2009, the contents of which are hereby incorporated by reference.

### BACKGROUND

The invention relates to a vehicle, in particular a motor vehicle, comprising a waste heat-generating drive device, in particular an engine, and an air conditioning system.

In drive devices of vehicles, in particular also the internal combustion engines of motor vehicles, an appreciable quantity of waste heat occurs during operation. This is discharged via a drive cooling device, with a coolant, mostly water, at the same time being heated, and/or is reflected in hot exhaust gases which are discharged via a corresponding exhaust gas expulsion device.

In this context, motor vehicles have basically been proposed which utilize the waste heat of the internal combustion engine in order to lower the fuel consumption. For example, it was proposed to use thermoelectric generators based on Peltier elements which serve for relieving the dynamo so as to use less mechanical energy of the internal combustion engine. Further developments employ a steam circuit in order to obtain mechanical energy from the waste heat. Moreover, it was proposed to generate additional kinetic energy with the aid of a Stirling engine, in order to drive a vehicle, cf., for example, DE 10 2007 000 189 A1. The mechanical energy released is used for driving the vehicle, for example by an EVT gear.

### SUMMARY

One possible object is to specify a vehicle, in particular a motor vehicle, in which waste heat can be used especially advantageously.

The inventors propose for the cooling device to be designed as an absorption refrigerating machine, in particular a diffusion absorption refrigerating machine, which uses the waste heat from the drive device.

The waste heat from the drive device, in particular the engine, can thereby be used for the generation of cold. In this case, it is proposed to use, instead of a conventional air conditioning compressor or conventional cooling device for components to be cooled, an absorption refrigerating machine which especially advantageously uses the waste heat from the engine.

Absorption refrigerating machines are basically known in the related art. In these, in contrast to a compression refrigerating machine, compression takes place as a result of a temperature-influenced dissolving of the refrigerant in a solvent (“thermal compressor”). An absorption refrigeration machine additionally has a solvent circuit. The two components, solvent and refrigerant, are often also designated in summary as a working medium. A precondition is that the refrigerant is completely soluble in the solvent. Combinations often used are water as refrigerant and lithium bromide as solvent or else ammonia as refrigerant and water as solvent. In the circuit, the working media are first separated from one another in what is known as an ejector, in that the solution is heated. The refrigerant evaporates first on account of the lower evaporation temperature, after which the vapor of the refrigerant is freed of the co-evaporated solvent residues by a liquid separator. In a condenser, the refrigerant is liquefied, so as to be evaporated in the evaporator, while at the same time taking up the ambient heat, thus giving rise to the beneficial effect. The refrigerant vapor is then conducted into the absorber where a solution is again obtained. After being separated from the refrigerant, the solvent is introduced into the absorber after it has been expanded to the absorber pressure by a valve and cooled. It is the solvent circuit which is ultimately designated as a “thermal compressor”, since it takes over the corresponding tasks of the compressor of the compression refrigerating machine. In this case, in a classic absorption refrigerating machine, the only moved part used is a solvent pump in the solvent circuit. In such an embodiment, there may expediently be provision for the solvent pump to be operable, belt-driven, by the drive device and/or as a result of the forward movement of the vehicle. There is therefore no need for any further energy source in order to operate the absorption refrigerating machine.

Especially advantageously, however, a diffusion absorption refrigerating machine is used, which constitutes a variant of the absorption refrigerating machine and in which the pressure change is implemented as a partial pressure change, so that the last mechanically moved component is also dispensed with together with the solvent pump. However, a third component for the working medium is required, to be precise an inert gas, for example helium. Diffusion absorption refrigerating machines therefore require only the supply of the waste heat from the drive device so as to be able to operate reliably.

The cooling device, which is designed as an absorption refrigerating machine, thus affords a multiplicity of advantages. On the one hand, absorption refrigerating systems are essentially maintenance-free and free of wear, so that long reliable use is possible. Moreover, absorption refrigerating machines manage almost, in the case of the diffusion absorption refrigeration machine even completely, without movable parts. In comparison with a Stirling engine, the absorption refrigerating machine also has further advantages. Thus, the Stirling engine has to be integrated as an overall appliance, whereas, in the case of the absorption refrigerating machine, it is possible to arrange the individual component parts in a distributed manner. Furthermore, an absorption refrigerating machine is better suited to the temperatures and temperature differences occurring in a vehicle, in particular a motor vehicle.

If components to be cooled and an air conditioning system are present in the vehicle, especially advantageously only a single cooling device is used which is then assigned to the air conditioning system and to the components to be cooled. An additional component to be cooled may be, for example, a secondary assembly and/or an electronic component and/or a battery. In many hybrid vehicles, this is especially advantageous, since the air conditioning system is usually employed there in any case to cool electronic components. It should be pointed out that the drive cooling device of a vehicle which is operated at about 90° C. is usually not suitable for cooling electronic systems, since these often require temperatures which are lower than 40° C.

It should also be stressed that these proposals can be used not only for motor vehicles driven, in particular, by an internal combustion engine, but, of course, also for utilizing the waste heat from water-cooled or oil-cooled electric drives. It will be possible, for example, to utilize the waste heat from drive devices of a locomotive for the air conditioning of the passenger spaces of a train and/or the electronic running speed controllers.

As already mentioned, in particular, the conventional air conditioning compressor of an air conditioning system may be dispensed with. Moreover, fuel consumption is, of course, also reduced in this way, since usually the air conditioning compressor of an air conditioning system increases the fuel consumption by about 15%. In this connection, it should also be pointed out that a further advantage of the absorption refrigerating machine is that it operates with extremely low noise and therefore does not increase the noise level in the vehicle any further.

In a motor vehicle operated by an internal combustion engine generating exhaust gases, there may be provision for providing a heat exchanger for tapping the waste heat from exhaust gases of the vehicle which is used for operating the absorption refrigerating machine and for transmitting said waste heat to the absorption refrigerating machine. In such an embodiment, the heat of the exhaust gases from the engine is therefore used in order to operate the absorption refrigerating machine.

Additionally or alternatively, there may be provision for providing a drive cooling device, circulating a coolant, for cooling the drive device, a heat exchanger for cooling the drive device being followed by a heat exchanger for tapping the waste heat carried by the coolant and for transmitting said waste heat to the absorption refrigerating machine. This is therefore where the utilization of the waste heat which has occurred comes in, this waste heat being in the coolant, for example the cooling water, heated as a result of the cooling of the drive device. A heat exchanger of this type for the absorption refrigerating machine may be arranged, for example, upstream of a compressor in which the coolant, in particular water, is cooled again. Particularly in motor vehicles, an absorption refrigerating machine can be used especially expediently, in contrast, for example, to a Stirling engine, since the temperature differences in the drive coolant circuit mostly amount to only 10° C. to 15° C., for which a Stirling engine would be completely unsuitable. Moreover, as already mentioned, tapping the waste heat in the drive cooling device can also be used in the case of cooled electric drive devices.

During a cold start of the drive device, a certain time elapses before the absorption refrigerating machine can perform its work. In order to avoid this time, there may be provision for the absorption refrigerating machine to be operated with electrically generated heat from an electrical heating device until a predetermined operating temperature is reached. In particular, in this case, it can also be questioned whether the air conditioning system is switched to active. Alternatively or additionally, there may also be provision for the cooling device to have a cold store for bridging operating phases free of waste heat. The air conditioning system can then be operated by the stored cold until the engine is warmed up. The cold store can subsequently be charged again by the absorption refrigerating machine.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a first embodiment of a motor vehicle according to the inventors' proposals, and

FIG. 2 shows a second embodiment of a motor vehicle according to the inventors' proposals.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

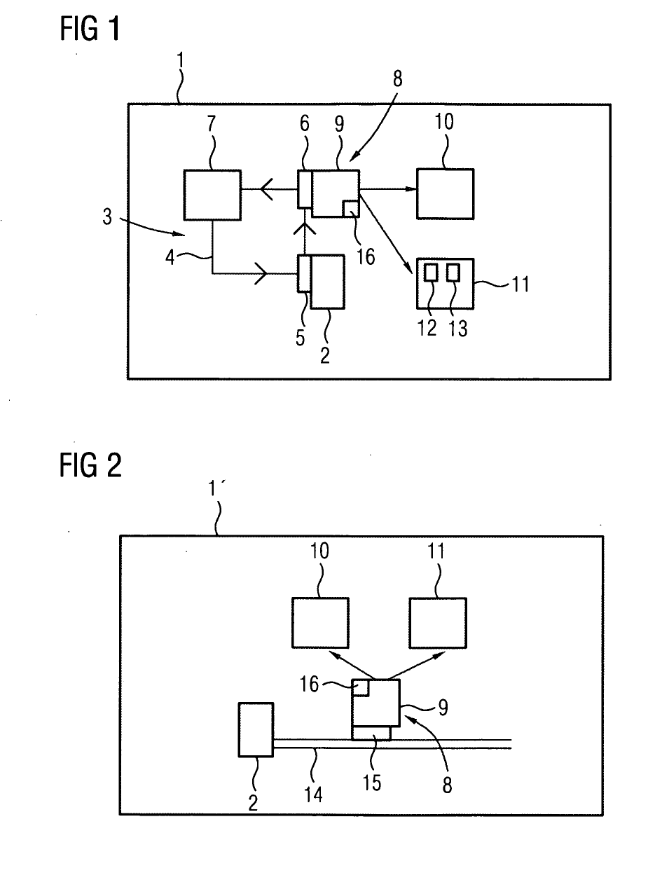

FIG. 1 shows a basic illustration of essential components of a motor vehicle 1 according to a first embodiment of the inventors' proposals. The motor vehicle 1 comprises as a drive device 2 an internal combustion engine which is cooled via a drive cooling device 3. In this case, water circulates as coolant in a drive coolant circuit 4, waste heat from the drive device 2 being taken up in a heat exchanger 5. The heat exchanger 5 is followed by a further heat exchanger 6 before the coolant is cooled again in a condenser 7.

The waste heat from the drive device 2 which is contained in the coolant at this point can be transferred via the heat exchanger 6 to a cooling device 8 which in the present case is designed as an absorption refrigerating machine 9, more precisely as a diffusion absorption refrigerating machine. The waste heat which is extracted from the drive coolant circuit 4 is therefore used for operating the absorption refrigerating machine 9 which converts it into cold. How this takes place is widely known in the related art and does not have to be presented in more detail here.

The cold which has occurred in the absorption refrigerating machine 9 is used for operating an air conditioning system 10 and for cooling further components 11 to be cooled, for example electronic components 12 or the battery 13.

FIG. 2 shows a further exemplary embodiment of a motor vehicle 1′ which is likewise operated via an internal combustion engine 2. Exhaust gases occur in the internal combustion engine 2 and are transferred via a corresponding discharge device 14. The waste heat contained in the exhaust gases serves in turn, via a heat exchanger 15, for operating a cooling device 8 designed as an absorption refrigerating system 9. The cold which has thus occurred serves in turn for operating an air conditioning system 10 and for cooling further components 11 to be cooled.

Finally, it should also be pointed out that, both in the first exemplary embodiment and in the second exemplary embodiment, the cooling device 8 may comprise a cold store 16 so that, during a cold start of the drive device 2, it is nevertheless possible to operate, for example, the air conditioning system 10 directly by utilizing the cold of the cold store 16. When the drive device 2 has reached a specific operating temperature, the cold store is no longer used and is charged again by the absorption refrigerating machine 9.

Alternatively, it is also conceivable to use an electric heating device in order to operate the absorption refrigerating machine 9 until the predetermined operating temperature is reached.

Finally, it should also be noted that the absorption refrigerating machine 9 does not have to be a diffusion absorption refrigerating machine, but a classic absorption refrigerating machine with a solvent pump may also be used. This can then be used, belt-driven, to especial advantage.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-6. (canceled)

7. A motor vehicle, comprising:
a vehicle engine serving as a waste heat-generating drive device; and
an air conditioning system to cool an interior and/or at least one component of the vehicle, the air conditioning system comprising an absorption refrigerating machine, which uses waste heat from the drive device and operates based on a temperature-influenced dissolving of a refrigerant in a solvent.

8. The vehicle as claimed in claim 7, wherein
in the absorption refrigerating machine, the solvent is circulated using a solvent pump, and
the solvent pump is driven by the vehicle engine and/or as a result of movement of the vehicle.

9. The vehicle as claimed in claim 7, further comprising:
an exhaust heat exchanger to tap waste heat from vehicle exhaust gases; and
a heat exchange conduit to transmit the waste heat from the exhaust heat exchanger to the absorption refrigerating machine.

10. The vehicle as claimed in claim 7, wherein
a coolant circuit circulates the coolant between an engine heat exchanger and a refrigeration heat exchanger,
the engine heat exchanger cools the vehicle engine, and
the refrigeration heat exchanger taps waste heat from the coolant and transmits the waste heat to the absorption refrigerating machine.

11. The vehicle as claimed in claim 7, wherein the vehicle comprises at least one of a secondary assembly, an active electronic component and a battery, which is cooled by the absorption refrigerating machine.

12. The vehicle as claimed in claim 7, wherein the air conditioning system has a cold store to cool the interior and/or at least one component of the vehicle between operating phases, when waste heat is not available.

13. The vehicle as claimed in claim 7, wherein the absorption refrigerating machine is a diffusion absorption refrigerating machine in which pressure change is implemented as a partial pressure change using an inert gas.

14. The vehicle as claimed in claim 7, wherein the vehicle engine is an internal combustion engine.

15. The vehicle as claimed in claim 8, further comprising:
an exhaust heat exchanger to tap waste heat from vehicle exhaust gases; and
a heat exchange conduit to transmit the waste heat from the exhaust heat exchanger to the absorption refrigerating machine.

16. The vehicle as claimed in claim 15, wherein
a coolant circuit circulates the coolant between an engine heat exchanger and a refrigeration heat exchanger,
the engine heat exchanger cools the vehicle engine, and
the refrigeration heat exchanger taps waste heat from the coolant and transmits the waste heat to the absorption refrigerating machine.

17. The vehicle as claimed in claim 16, wherein the vehicle comprises at least one of a secondary assembly, an active electronic component and a battery, which is cooled by the absorption refrigerating machine.

18. The vehicle as claimed in claim 17, wherein the air conditioning system has a cold store to cool the interior and/or at least one component of the vehicle between operating phases, when waste heat is not available.

19. The vehicle as claimed in claim 18, wherein the absorption refrigerating machine is a diffusion absorption refrigerating machine in which pressure change is implemented as a partial pressure change using an inert gas.

20. The vehicle as claimed in claim 19, wherein the vehicle engine is an internal combustion engine.
